(19) United States
(12) Patent Application Publication
(10) Pub. No.: US 2013/0268328 A1
(43) Pub. Date: Oct. 10, 2013

(54) GENERATING A DEAL SCORE TO INDICATE A RELATIVE VALUE OF AN OFFER

(71) Applicants: Kaushal Kurapati, Cupertino, CA (US); Amit Dayal, Bangalore (IN); Durai V. Balusamy, San Ramon, CA (US)

(72) Inventors: Kaushal Kurapati, Cupertino, CA (US); Amit Dayal, Bangalore (IN); Durai V. Balusamy, San Ramon, CA (US)

(73) Assignee: YAHOO! INC., Sunnyvale, CA (US)

(21) Appl. No.: 13/442,602

(22) Filed: Apr. 9, 2012

(51) Int. Cl. G06Q 30/02

(52) U.S. Cl. 705/14.1

(57) ABSTRACT

Techniques are described herein for generating a deal score to indicate a relative value of an offer for a commerce element. In one example, the deal score for a particular offer is based on a difference between a discounted price specified by the particular offer and an average of discounted price(s) specified by other offer(s). If the difference reaches a threshold, then a relatively high deal score is generated. Otherwise, a relatively low deal score is generated. In another example, the deal score is based on a difference between an intermediate value and the discounted price specified by the present offer. The intermediate value may be provided by combining discounted price(s) specified by other offer(s) and the non-discounted price of the commerce element being offered. If the difference reaches a threshold, then a relatively high deal score is generated. Otherwise, a relatively low deal score is generated.

### BACKGROUND OF THE INVENTION

1. Field of the Invention

The present invention relates to comparing a discounted offer to other offer(s) to generate a deal score that indicates a relative value of the discounted offer with respect to the other offer(s).

2. Background

Electronic commerce, or e-commerce, involves the buying and selling of goods and/or services over electronic systems such as the Internet and other computer networks. The amount of trade conducted electronically has grown significantly with the widespread adoption of broadband Internet, smartphones, tablet personal computers (PCs) and other multimedia devices. As e-commerce continues to grow, retailers continue to devise new strategies to attract more customers. As such, e-commerce is constantly evolving.

One recent trend that has developed in e-commerce is discount retailing. Discount retailing websites and services that use discounted deals as the core of their business are becoming increasingly common and thus are becoming major players in the online shopping industry. Typically, these websites and services feature a deal of the day, where the deal is typically a coupon or gift certificate that can be used when purchasing a particular good and/or service. Depending on the deal being offered, it is not unrealistic for businesses to see hundreds or even thousands of individuals taking advantage of their deal. Sales can increase dramatically in just a few minutes or hours, boosting profits and promoting the business and the products offered by the business. Consequently, the number of businesses participating in such a business model is increasing on a daily basis.

One drawback to the ever-increasing number of discounted deals being offered via the Internet is that consumers are becoming overwhelmed. Consumers often do not have access to a reliable pricing context for the particular discount being offered. Accordingly, consumers are often at a disadvantage when deciding whether or not to purchase the discounted deal because there is not a way for the consumers to know whether the discounted deal represents a relatively good value.

### BRIEF SUMMARY OF THE INVENTION

Various approaches are described herein for, among other things, providing deal scores for offers that specify discounted prices (a.k.a. discounted offers) for good(s) and/or service(s). The offers may be represented as a coupon, a gift certificate, etc. A deal score indicates a relative value of a present offer. For example, the deal score may be based on a difference between a discounted price specified by the present offer and an average of discounted price(s) specified by respective other offer(s). In this example, if a difference between the discounted price specified by the present offer and the average discounted price is greater than (or equal to) a threshold, then a relatively high deal score may be generated. If the difference is less than the threshold, then a relatively low deal score may be generated. In another example, the deal score may be based on a difference between an intermediate value and the discounted price of the present offer. For instance, the intermediate value may be based on a combination of the discounted price(s) specified by respective other offer(s) and a non-discounted price of the good and/or service being offered. In this example, if the difference between the discounted price specified by the present offer and the intermediate value is greater than (or equal to) a threshold, then a relatively high deal score may be generated. If the difference is less than the threshold, then a relatively low deal score may be generated.

An example method is described in which a present offer that specifies a discounted price of first commerce element(s) and other offer(s) that specify respective discounted price(s) of second commerce element(s) are compared. The first commerce element(s) are associated with a first category of subject matter, and the second commerce element(s) are associated with a second category of subject matter. Each first commerce element and each second commerce element is a good or a service. The first category of subject matter and the second category of subject matter have a first measure of similarity that reaches a threshold. A deal score for the present offer is generated based on the comparing of the present offer and the other offer(s). The deal score indicates a relative value of the present offer with respect to the other offer(s).

A system is described that includes comparison logic and scoring logic. The comparison logic is configured to compare a present offer that specifies a discounted price of first commerce element(s) and other offer(s) that specify respective discounted price(s) of second commerce element(s). The first commerce element(s) are associated with a first category of subject matter, and the second commerce element(s) are associated with a second category of subject matter. Each first commerce element and each second commerce element is a good or a service. The first category of subject matter and the second category of subject matter have a first measure of similarity that reaches a threshold. The scoring logic is configured to generate a deal score for the present offer based on a comparison of the present offer and the other offer(s). The deal score indicates a relative value of the present offer with respect to the other offer(s).

An example computer program product is described that includes a computer-readable medium having computer program logic recorded thereon for enabling a processor-based system to provide a deal score to user(s). The computer program product includes a first program logic module and a second program logic module. The first program logic module is for enabling the processor-based system to compare a present offer that specifies a discounted price of first commerce element(s) and other offer(s) that specify respective discounted price(s) of second commerce element(s). The first commerce element(s) are associated with a first category of subject matter, and the second commerce element(s) are associated with a second category of subject matter. Each first commerce element and each second commerce element is a good or a service. The first category of subject matter and the second category of subject matter have a first measure of similarity that reaches a threshold. The second program logic module is for enabling the processor-based system to generate a deal score for the present offer based on the comparing of the present offer and the other offer(s).

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example system in accordance with an embodiment described herein.

FIG. 2 depicts a flowchart of an example method for generating a deal score for a present offer in accordance with an embodiment described herein.

FIG. 3 depicts a flowchart of an example method for determining whether past offer(s) are similar to a present offer in accordance with an embodiment described herein.

FIG. 4 depicts a flowchart of an example method for generating a deal score based on an average of discounted price(s) in accordance with an embodiment described herein.

FIG. 5 depicts a flowchart of an example method for generating a deal score based on a combination of a non-discounted price and discounted price(s) in accordance with an embodiment described herein.

FIG. 6 is a block diagram of an example implementation of a deal comparison module shown in FIG. 1 in accordance with an embodiment described herein.

FIG. 7 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Example embodiments are capable of providing deal scores for offers that specify discounted prices (a.k.a. discounted offers) for good(s) and/or service(s). The offers may be represented as a coupon, a gift certificate, etc. A deal score indicates a relative value of a present offer. In example embodiments, the deal score is based on a difference between a discounted price specified by the present offer and an average of discounted price(s) specified by respective other offer(s). In this embodiment, if the difference between the discounted price specified by the present offer and the average discounted price is greater than (or equal to) a threshold, then a relatively high deal score is generated. If the difference is less than the threshold, then a relatively low deal score is generated. In another example embodiment, the deal score is based on a difference between an intermediate value and the discounted price of the present offer. The intermediate value is provided by combining discounted price(s) specified by respective other offers and the non-discounted price of the good and/or service being offered. In this embodiment, if the difference between the discounted price specified by the present offer and the intermediate value is greater than (or equal to) a threshold, then a relatively high deal score is generated. If the difference is less than the threshold, then a relatively low deal score is generated.

Techniques described herein have a variety of benefits as compared to conventional techniques where discounted offers are provided without a deal score. For instance, the techniques described herein may assist a user in making a decision as to whether or not to accept (e.g., purchase) a discounted offer. For example, if a salon is offering a 50% discount for spa services in a given location, a consumer may not be able to ascertain whether this discounted offer represents a relatively good value. For example, the consumer may not know how this discounted offer compares with other offers offered by this salon or by other salons in the area. Thus, a deal score is provided that indicates a relative value of the discounted offer. Using the deal score, a user can determine whether or not the discounted offer is, in fact, a deal worth purchasing.

II. Example Embodiments

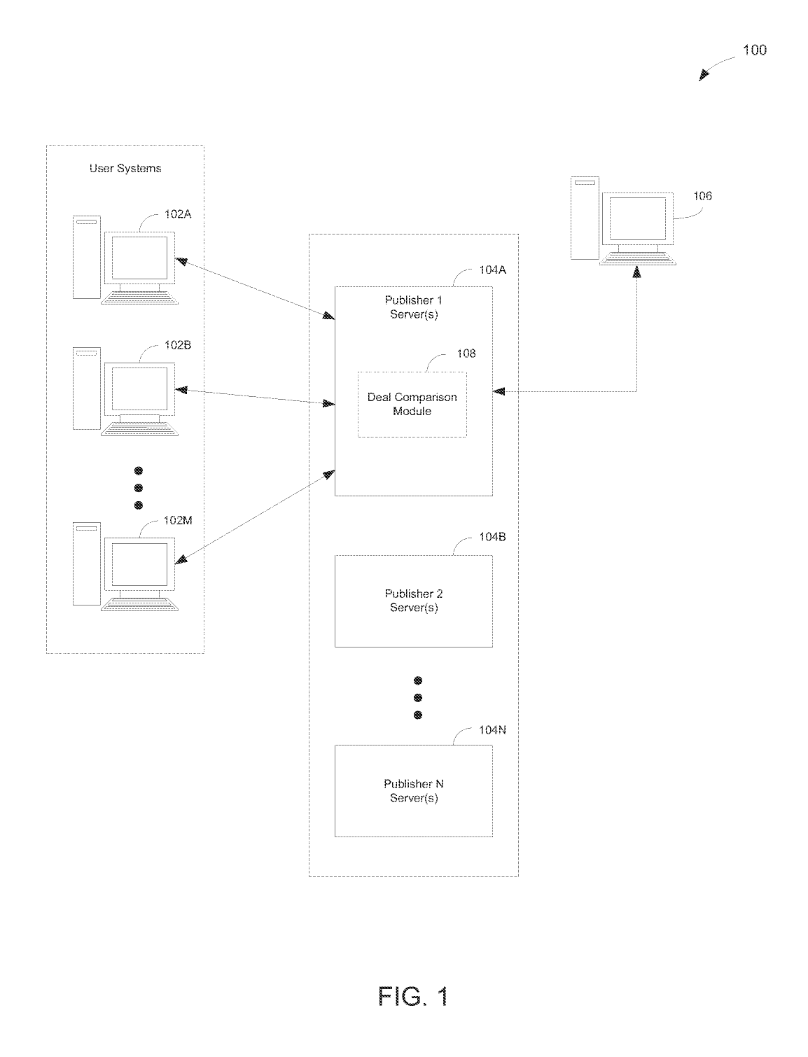

FIG. 1 is a block diagram of an example system 100 in accordance with an embodiment described herein. Generally speaking, system 100 operates to compare a present offer that specifies a discounted price (e.g., via a coupon, gift certificate, and/or the like) to other offer(s) to generate a deal score that indicates a relative value of the present offer with respect to the other offer(s). Each offer may be provided by a merchant (e.g., a seller of good(s) and/or service(s)) for presentation to users via one or more sites (e.g., Web sites). For instance, the offers may be published by publishers when such site(s) are accessed by certain users of a network. Each offer may specify one or more commerce elements that are offered for purchase. Each commerce element is a good or a service that belongs to one or more categories of subject matter (e.g., clothing, spa services, concert tickets, etc.).

In example embodiments, the deal score, which indicates a relative value of the present offer with respect to the other offer(s), may be based on an average of discounted price(s) specified by the respective other offer(s). In this embodiment, if the difference between the discounted price specified by the present offer and the average discounted price is greater than (or equal to) a threshold, then a relatively high deal score is generated. If the difference is less than the threshold, then a relatively low deal score is generated.

In other example embodiments, the deal score may be based on an intermediate value that is provided by combining discounted price(s) specified by the respective other offer(s) and a non-discounted price of the good(s) and/or service(s) being offered. In this embodiment, if the difference between the discounted price specified by the present offer and the intermediate value is greater than (or equal to) a threshold, then a relatively high deal score is generated. If the difference is less than the threshold, then a relatively low deal score is generated.

As shown in FIG. 1, system 100 includes a plurality of user systems 102A-102M, a plurality of publisher servers 104A-104N, and at least one merchant system 106. Communication among user systems 102A-102M, publisher servers 104A-104N, and merchant system 106 is carried out over a network using well-known network communication protocols. The network may be a wide-area network (e.g., the Internet), a local area network (LAN), another type of network, or a combination thereof.

User systems 102A-102M are computers or other processing systems each including one or more processors, that are capable of communicating with any one or more of publisher servers 104A-104N. For example, each of user systems 102A-102M may include a client that enables a user who owns (or otherwise has access to) the user system to access sites (e.g., Web sites) that are hosted by publisher servers 104A-104N. For instance, a client may be a Web crawler, a Web browser, a non-Web-enabled client, or any other suitable type of client. By way of example, each of user systems 102A-102M is shown in FIG. 1 to be communicatively coupled to publisher 1 server(s) 104A for the purpose of accessing a site published by publisher 1. Persons skilled in the relevant art(s) will recognize that each of user systems 102A-102M is capable of connecting to any of publisher servers 104A-104N for accessing the sites hosted thereon.

Publisher servers 104A-104N are computers or other processing systems, each including one or more processors, that are capable of communicating with user systems 102A-102M. Each of publisher servers 104A-104N is configured to host a site (e.g., a Web site) published by a corresponding publisher 1-N so that such site is accessible to users of system 100 via user systems 102A-102M. Each of publisher servers 104A-104N is further configured to provide instances of one or more deal scores regarding one or more discounted offers (e.g., coupons, gift certificates, etc.) for good(s) and/or service(s) to users of system 100 when those users access a Web site that is hosted by the respective publisher server.

Publisher servers 104A-104N are further configured to execute software programs that provide information to users in response to receiving requests, such as hypertext transfer protocol (HTTP) requests, from users, instant messaging (IM) applications, or web-based email. For example, the information may include Web pages, images, other types of files, output of executables residing on the publisher servers, IM chat sessions, emails, coupons, gift certificates, advertisements, etc. In accordance with this example, the software programs that are executing on publisher servers 104A-104N may provide Web pages and/or emails that include interface elements (e.g., buttons, widgets, hyperlinks, etc.) that a user may select for accessing the other types of information. The Web pages may be provided as hypertext markup language (HTML) documents and objects (e.g., files) that are linked therein, for example.

One type of software program that may be executed by any one or more of publisher servers 104A-104N is a deal comparison engine. For instance, publisher 1 server(s) 104A is shown to include deal comparison module 108, which is configured to execute a deal comparison engine. Deal comparison module 108 is capable of generating one or more deal scores for one or more present offers (i.e., offers that are currently available for acceptance) presented via a Web site hosted by publisher server 104A. Deal comparison module 108 generates a deal score for a present offer by comparing the present offer to other offer(s) (e.g., other present offer(s) and/or past offer(s)) to determine the relative value of the present offer with respect to the other offer(s). In some example embodiments, the deal score is represented by a numeric value, where a high numeric value indicates a high relative value, and a low numeric value indicates a low relative value. In other example embodiments, the deal score is represented by a text description (e.g., in addition to or in lieu of a numeric value) that describes the relative value of the present offer. For example, the relative value of a present offer may be described by using a text description such as, “Poor,” “Average,” “Good,” or “Great.”

In some example embodiments, each text description may correlate to a respective numeric value range. Upon determining that a deal score falls within a specified numeric value range, the corresponding text description may be associated with the present offer. For example, if the determined deal score for a present offer falls within a numeric value range of 1-25, then the present offer may be provided with a text description of “Poor.” If the determined deal score for a present offer falls within a numeric value range of 26-50, then the present offer may be provided with a text description of “Average.” If the determined deal score for a present offer falls within a numeric value range of 51-75, then the present offer may be provided with a text description of “Good.” If the determined deal score for a present offer falls within a numeric value range of 76-100, then the present offer may be provided with a text description of “Great.”

It is noted that the set of numeric value ranges and the text descriptions used for the deal score in the example above are provided for illustrative purposes and are not intended to be limiting. It will be recognized that any set of suitable numeric ranges and text descriptions may be used.

Deal comparison module 108 is configured to compare offers that specify respective discounted prices for respective commerce elements that belong to similar (e.g., same) categor(ies) of subject matter. Deal comparison module 108 determines whether a category of subject matter associated with a commerce element specified in a present offer and one or more categories of subject matter associated with one or more respective commerce elements specified in one or more other offers are similar based on whether the categories have a measure of similarity that reaches (e.g., is greater than or equal to) a threshold. If the threshold is reached with regard to an offer, deal comparison module 108 determines that the category of subject matter for the present offer and the category of subject matter for that offer are similar, and then compares the present offer to that offer for the purpose of determining a relative value of the present offer. If the threshold is not reached with regard to an offer, deal comparison module 108 determines that the category of subject matter for the present offer and the category of subject matter for that offer are not similar, and therefore, does not compare the present offer to that offer for the purpose of determining a relative value of the present offer. The measure of similarity between categories of subject matter may be determined using various techniques known in the art.

After determining whether the category of subject matter for the commerce element specified in the present offer and the one or more respective categories of subject matter for the one or more respective commerce elements specified in the one or more respective other offers are similar, deal comparison module 108 generates a deal score for the present offer that indicates a relative value of the present offer with respect to the other offer(s) for which the threshold is reached.

In an example embodiment, deal comparison module 108 generates the deal score by determining an average of the discounted price(s) specified by the respective other offer(s) for which the threshold is reached and calculates a difference between the discounted price specified by the present offer and the average discounted price. If the difference is greater than (or equal to) a threshold, then the deal score is generated to indicate that the relative value of the present offer is relatively high. If the difference is less than the threshold, then the deal score is generated to indicate that the relative value of the present offer is relatively low.

For example, suppose that a present offer specifies a discounted offer of 50% off for a one-hour massage that normally costs $40, thereby providing a discounted price of $20. Further suppose that deal comparison module 108 determines that two other offers for one-hour massages are also being offered, one of which specifies a discounted offer of 40% off a one-hour massage that normally costs $30 (thereby providing a discounted price of $18) and the other of which specifies a discounted offer of 60% off a one-hour massage that normally costs $80 (thereby providing a discounted price of $32). In accordance with this example, to generate the deal score, deal comparison module 108 may determine an average of the discounted prices for the other offers. In this example, the average discounted price is ($18+$32)/2=$25. Deal comparison module 108 may then calculate the difference between the discounted price specified by the present offer and the average discounted price. In this example, the difference is $25−$20=$5. If the threshold is set to a value of at least $4, then the deal score generated may indicate that the relative value of the present offer is relatively high because the threshold is reached. However, if the threshold is set to a value of at least $8, then the deal score may indicate that the relative value of the present offer is relatively low because the threshold is not reached.

In another embodiment, deal comparison module 108 generates a deal score by calculating the difference between the discounted price of the commerce element specified by the present offer to a non-discounted (i.e., regular) price of a similar (e.g., same) commerce element. If the difference is greater than (or equal to) a threshold, then the deal score is generated to indicate that the relative value of the present offer is relatively high. If the difference is less than the threshold, then the deal score is generated to indicate that the relative value of the present offer is relatively low.

For example, suppose that a present offer specifies a discounted price of $45 for a handbag. Further suppose that the regular price for the handbag is $55. If the threshold is set to a value of at least $7.50, then the deal score may be generated to indicate that the relative value of the present offer is relatively high because the threshold is reached. However, if the threshold is set to a value of at least $15, then the deal score may be generated to indicate that the relative value of the present offer is relatively low because the threshold is not reached.

In another embodiment, deal comparison module 108 generates a deal score by combining a non-discounted price for a commerce element with one or more discounted prices of one or more respective commerce elements specified in one or more respective other offers to provide a combined value. A difference between the discounted price specified by the present offer and the combined value (i.e., an intermediate value) is then calculated. If the difference is greater than (or equal to) a threshold, then the deal score may be generated to indicate that the relative value of the present offer is relatively high. If the difference is less than the threshold, then the deal score may be generated to indicate that the relative value of the present offer is relatively low.

For example, suppose that a present offer specifies a discounted offer of 60% off for an oil change service that normally costs $40, thereby providing a discounted price of $16. Further suppose that deal comparison module 108 determines that two other offers for a similar oil change service provided by the same merchant were offered in the past. The first past offer specifies a discounted offer of 40% off for the oil change service, thereby providing a discounted price of $24. The second past offer specifies a discounted offer of $30% off for the oil change service, thereby providing a discounted price of $28). To generate the deal score, deal comparison module 108 may combine the non-discounted price with the discounted prices to provide an intermediate value. For instance, deal comparison module 108 may provide the intermediate value by averaging the non-discounted price with the discounted prices associated with the two past offers. In this example, the intermediate value is equal to ($40+$24+$28)/3=$30.67. Deal comparison module 108 then may calculate the difference between the discounted price specified by the present offer and the intermediate value. In this example, the difference is $30.67−$16=$14.67. If the threshold is set to a value of at least $5, then the deal score may be generated to indicate that the relative value of the present offer is relatively high because the threshold is reached. However, if the threshold is set to a value of at least $15, then the deal score may be generated to indicate that the relative value of the present offer is relatively low because the threshold is not reached.

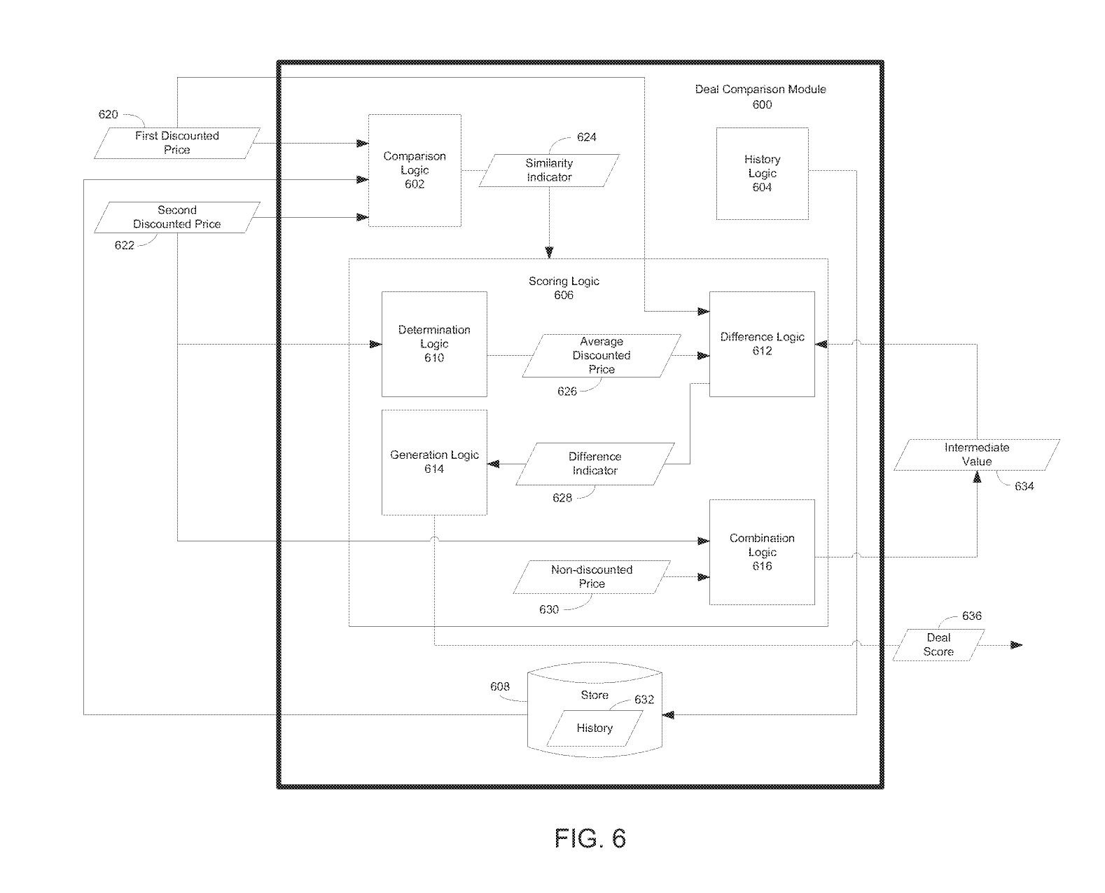

In some example embodiments, deal comparison module 108 crawls various merchant websites to identify the non-discounted price of a particular good and/or service. In some other example embodiments, the non-discounted price of a particular good and/or service is provided to deal comparison module 108 via input from a user. Once identified, the non-discounted price may be stored in a data store (e.g., data store 608 shown in FIG. 6).

Merchant system 106 is a computer or other processing system, including one or more processors, that is capable of providing discounted offers (e.g., coupons, gift certificates, etc.) for goods and/or services via a Web site hosted by a respective publisher server. By way of example, merchant system 106 is shown in FIG. 1 to be communicatively coupled to publisher 1 server(s) 104A for the purpose of serving offers to publisher 1. However, persons skilled in the relevant art(s) will recognize that merchant system 106 is capable of connecting to any one or more of publisher servers 104A-104N for serving offers thereto. In addition, although one merchant system 106 is depicted in FIG. 1, persons skilled in the relevant art(s) will recognize that any number of merchant systems may be communicatively coupled among publisher servers 104A-104N.

Although merchant system 106 and user systems 102A-102M are depicted as desktop computers in FIG. 1, persons skilled in the relevant art(s) will appreciate that merchant system 106 and user systems 102A-102M may include any browser-enabled system or device, including but not limited to a laptop computer, a tablet computer, a personal digital assistant, a cellular telephone, or the like.

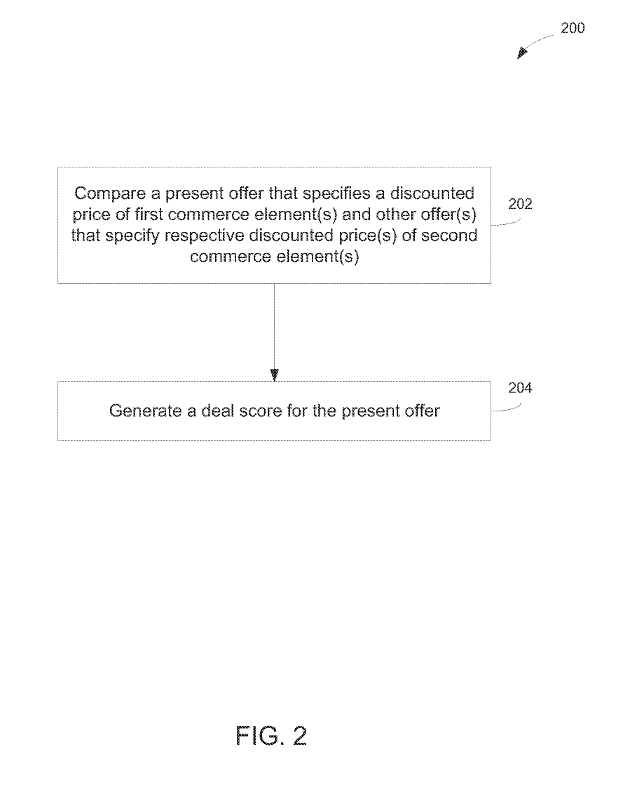

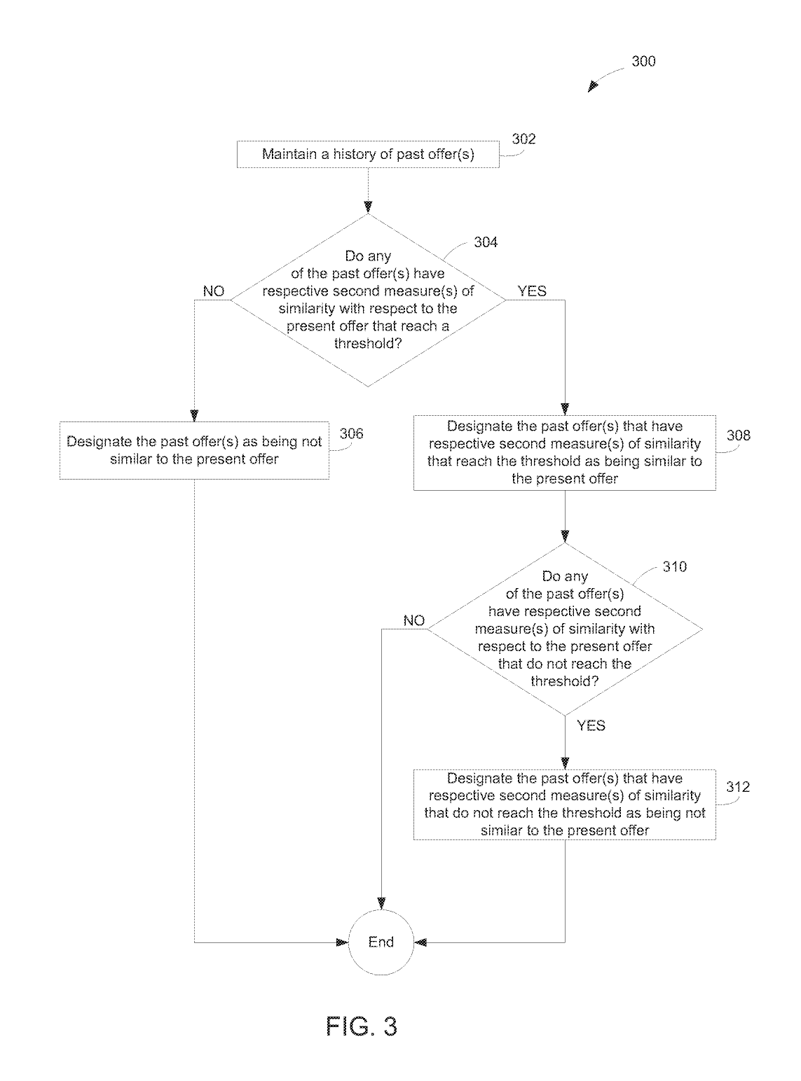

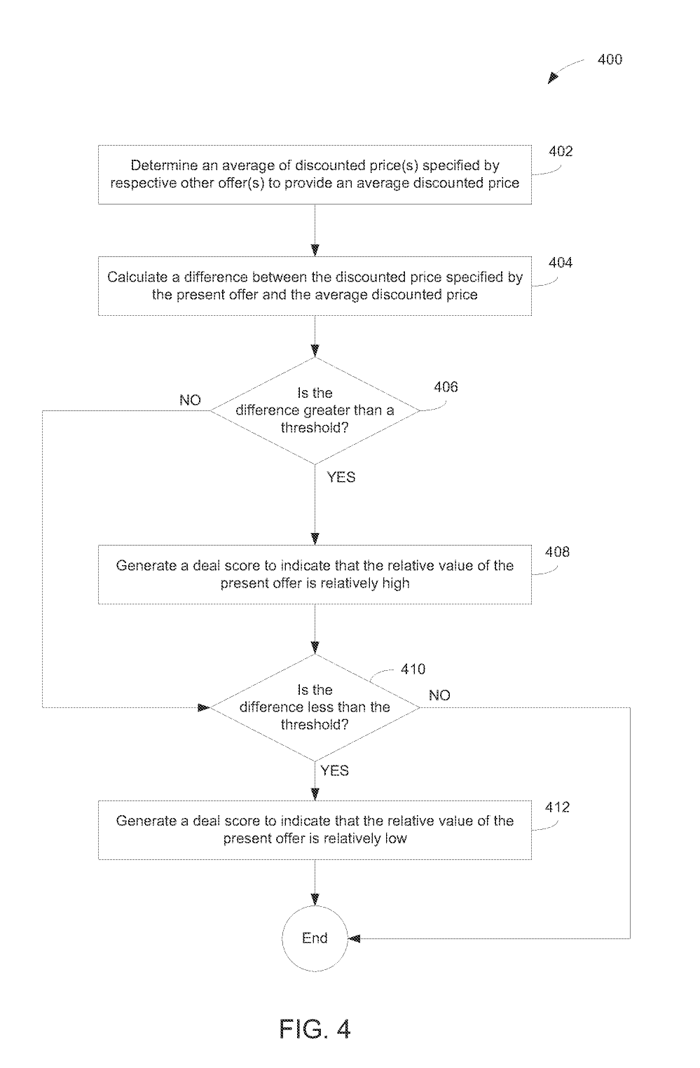

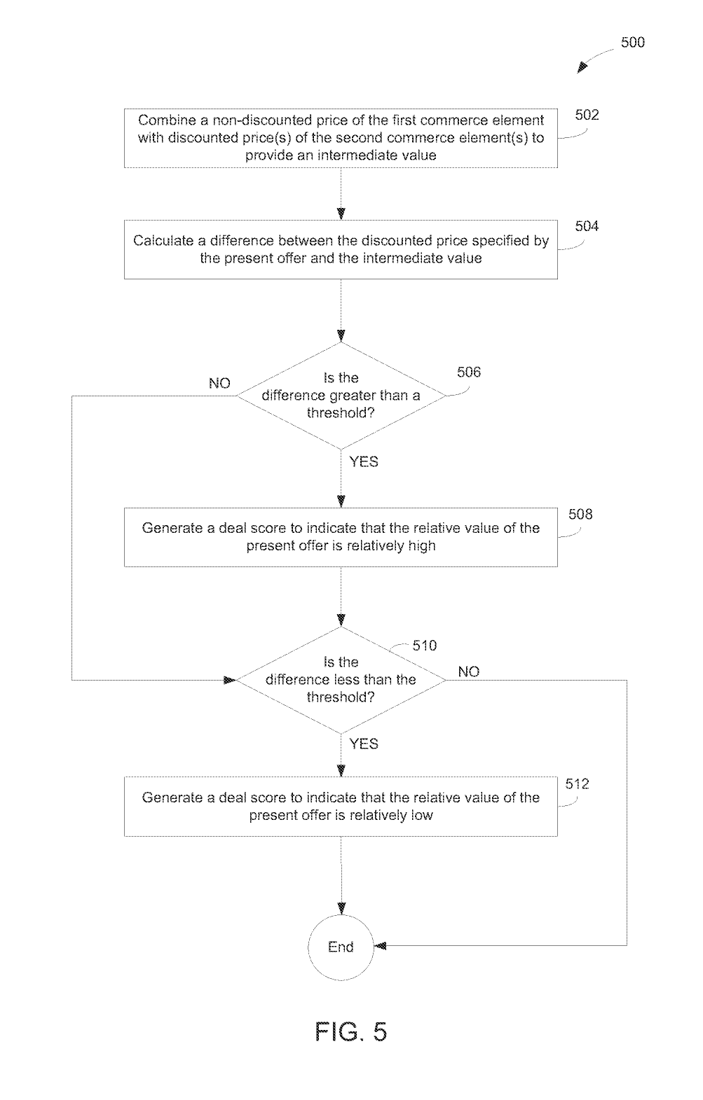

FIG. 2 depicts a flowchart 200 of an example method for generating a deal score for a present offer in accordance with an embodiment described herein. FIG. 3 depicts a flowchart 300 of an example method for determining whether past offer(s) are similar to a present offer in accordance with an embodiment described herein. FIG. 4 depicts a flowchart 400 of an example method for generating a deal score based on an average of discounted price(s) in accordance with an embodiment described herein. FIG. 5 depicts a flowchart 500 of an example method for generating a deal score based on a combination of a non-discounted price and discounted price(s) in accordance with an embodiment described herein. Flowcharts 200, 300, 400, and 500 may be performed by deal comparison module 108, for example. For illustrative purposes, flowcharts 200, 300, 400, and 500 are described with respect to deal comparison module 600 shown in FIG. 6, which is an example of deal comparison module 108, according to an embodiment. As shown in FIG. 6, deal comparison module 600 includes comparison logic 602, history logic 604, scoring logic 606, and a data store 608. Scoring logic 606 includes determination logic 610, difference logic 612, generation logic 614, and combination logic 616. Further structural and operational embodiments will be apparent to persons skilled in the relevant art(s) based on the discussion regarding flowcharts 200, 300, 400, and 500.

As shown in FIG. 2, the method of flowchart 200 begins at step 202. In step 202, a present offer that specifies a discounted price of first commerce element(s) and other offer(s) that specify respective discounted price(s) of second commerce element(s) are compared. Each of the first commerce element(s) and the second commerce element(s) is a good or a service. The first commerce element(s) are associated with a first category of subject matter, and the second commerce element(s) are associated with a second category of subject matter. The first category of subject matter and the second category of subject matter have a first measure of similarity that reaches a first threshold. Thus, the first category of subject matter is similar to the second category of subject matter.

In an example implementation, comparison logic 602 compares the present offer, which specifies first discounted price 620, to the other offers, which specify second discounted price 622 to provide a similarity indicator 624 to scoring logic 606. Similarity indicator 624 indicates whether the first category of subject matter associated with the first commerce element(s) and the second category of subject matter associated with the second commerce element(s) have a first measure of similarity that reaches the first threshold. For example, if the first threshold is reached, then similarity indicator 624 may be assigned a value of “true” (e.g., a value of “1”), which enables scoring logic 606 to use the other offer(s) to generate the deal score. If the first threshold is not reached, then similarity indicator 624 may be assigned a value of “false” (e.g., a value of “0”) to prevent scoring logic 606 from using the other offer(s) to generate the deal score.

In an example embodiment, the first threshold may be exposed as a configurable parameter to a system administrator, thereby allowing a user to select the required measure of similarity between categories of subject matter.

At step 204, a deal score is generated for the present offer based on the comparing of the present offer and the other offer(s). The deal score indicates a relative value of the present offer with respect to the other offer(s). In an example implementation, generation logic 614 generates deal score 636 to indicate the relative value of the present offer with respect to the other offer(s). In one example, the deal score may be represented by a numeric value, where a high numeric value indicates a high relative value, and a low numeric value indicates a low relative value. In another example, the deal score may be represented by a text description (e.g., in addition to or in lieu of the numeric value) that describes the relative value of the present offer.

In some example embodiments, the deal score is provided via a Web site hosted by a publisher server (for example, publisher 1 server(s) 104A shown in FIG. 1). In some other example embodiments, the deal score is provided via email, short message service (SMS), instant message (IM), or any other suitable messaging technology.

In an example embodiment, the other offer(s) include other present offer(s). In another example embodiment, the other offer(s) include past offer(s) as described below with reference to FIG. 3. In yet another example embodiment, the other offer(s) include a combination of other present offer(s) and past offer(s).

In some example embodiments, one or more steps 202 and 204 of flowchart 200 may not be performed. Moreover, steps in addition to or in lieu of steps 202 and 204 may be performed.

One example method for determining whether past offer(s) are similar to a present offer will now be described with reference to flowchart 300 of FIG. 3. As shown in FIG. 3, the method of flowchart 300 begins at step 302. In step 302, a history of past offer(s) is maintained. In an example implementation, data store 608 maintains a history 632 of past offer(s).

At step 304, a determination is made whether any of the past offer(s) from the history of past offer(s) have respective second measure(s) of similarity with respect to the present offer that reach a second threshold. If it is determined that none of the past offer(s) have respective second measure(s) of similarity that reach a threshold, flow continues to step 306. Otherwise, flow continues to step 308.

In an example implementation, comparison logic 602 compares the present offer (e.g., first discounted price 620) to the past offer(s) from the history 632 of past offer(s) and provides a similarity indicator 624 to scoring logic 606. Similarity indicator 624 indicates whether the present offer and the past offer(s) have respective second measure(s) of similarity that reach the second threshold. For example, if the second threshold is reached with regard to one or more of the past offer(s), then similarity indicator 624 is assigned a value of “true” (e.g., a value of “1”) for these past offer(s), which enables scoring logic 606 to use these past offers when generating the deal score. If the second threshold is not reached one or more of the past offer(s), then similarity indicator is assigned a value of “false” (e.g., a value of “0”) for these past offer(s), which prevents scoring logic 606 from using these past offer(s) when generating the deal score.

At step 306, the past offer(s) from the history of past offers are designated as being not similar to the present offer. In an example implementation, comparison logic 602 designates that the past offer(s) from the history 632 of past offer(s) as being not similar to the present offer via similarity indicator 624. Upon completion of step 306, flowchart 300 ends.

At step 308, the past offer(s) that have respective second measure(s) of similarity that reach the second threshold are designated as being similar to the present offer. In an example implementation, comparison logic 602 designates the past offer(s) from the history 632 of past offer(s) that have respective second measures of similarity that reach the second threshold as being similar to the present offer via similarity indicator 624.

At step 310, a determination is made whether any of the past offer(s) from the history of past offer(s) have respective second measure(s) of similarity with respect to the present offer that do not reach the second threshold. If it is determined that one or more of the past offer(s) have respective second measure(s) of similarity that do not reach the second threshold, flow continues to step 312. Otherwise, flowchart 300 ends. In an example implementation, comparison logic 602 compares the present offer (e.g., first discounted price 620) to the past offer(s) from the history 632 of past offer(s) and provides similarity indicator 624 to scoring logic 606. As described above, similarity indicator 624 indicates whether the present offer and the past offer(s) have respective second measure(s) of similarity that reach the second threshold.

At step 312, the past offer(s) that have respective second measure(s) of similarity that do not reach the second threshold are designated as being not similar to the present offer. In an example implementation, comparison logic 602 designates the past offer(s) that have respective second measure(s) of similarity that do not reach the second threshold as being not similar to the present offer via similarity indicator 624.

In an example embodiment, the second measure(s) of similarity are based on at least a first location in which the present offer is offered and second location(s) in which the respective past offer(s) are offered. In accordance with this embodiment, the determination as to whether the second measure(s) of similarity reach the second threshold is based on whether the first location and the respective second location(s) are within a specified area of proximity.

For example, suppose the specified area of proximity is 25 miles. In this example, if the location in which the present offer is offered is within 25 miles from the location in which a particular past offer was offered, then a determination may be made that the second measure of similarity between the present offer and the particular past offer reaches the second threshold. In contrast, if the location in which the present offer is offered is more than 25 miles from the location in which the particular past offer was offered, then a determination may be made that the second measure of similarity between the present offer and the particular past offer does not reach the second threshold.

It is noted that the specified area of proximity in the example above is provided for illustrative purposes and is not intended to be limiting. It will be recognized that the specified area of proximity may have any suitable shape (e.g., circle, oval, square, rectangle, an irregular shape, etc.). If the specified area is based on a radius from the location in which the present offer is offered, the radius may be any suitable value. The specified area of proximity may be exposed as a configurable parameter to a system administrator, for example, thereby allowing the specified area of proximity to be selected to achieve desired performance.

In another example embodiment, the second measure(s) of similarity are based on at least difference(s) between a first time at which the present offer is offered and respective second time(s) at which the respective past offer(s) are offered. In accordance with this embodiment, the determination as to whether the second measure(s) of similarity reach the second threshold is based on the difference(s) between the first time and the respective second time(s) being less than (or equal to) a third threshold.

For example, suppose that the third threshold is 7 days. In this example, if a time in which the present offer is offered is within 7 days from a time in which a particular past offer was offered, then a determination may be made that the second measure of similarity between the present offer and the particular offer reaches the second threshold. In contrast, if the time in which the present offer is offered is more than 7 days after the time in which the particular past offer was offered, then a determination may be made that the second measure of similarity between the present offer and the particular past offer does not reach the second threshold.

It is noted that the third threshold in the example above is provided for illustrative purposes and is not intended to be limiting. It will be recognized that the third threshold may be set to any suitable period of time. For example, the third threshold may be exposed as a configurable parameter to a system administrator, thereby allowing the third threshold to be selected to achieve desired performance.

In yet another example embodiment, the second measure(s) of similarity are based on a combination of the examples provided above.

In some example embodiments, one or more steps 302, 304, 306, 308, 310, and/or 312 of flowchart 300 may not be performed. Moreover, steps in addition to or in lieu of steps 302, 304, 306, 308, 310, and/or 312 may be performed.

FIG. 4 depicts a flowchart 400 of an example implementation of step 204 of FIG. 2 in accordance with an embodiment described herein. As shown in FIG. 4, the method of flowchart 400 begins at step 402. In step 402, an average of discounted price(s) specified by respective other offer(s) is determined to provide an average discounted price. In an example implementation, determination logic 610 determines the average discounted price (e.g., average discounted price 626) of the one or more discounted prices (e.g., second discounted price 622).

In an example implementation, the other offer(s) include one or more other present offers and/or one or more past offers from the history of past offer(s).

At step 404, a difference between the discounted price specified by the present offer and the average discounted price is calculated. The difference indicates an extent to which the average discounted price is greater than the discounted price specified by the present offer. In an example implementation, difference logic 612 calculates the difference between the discounted price specified by the present offer (e.g., first discounted price 620) and the average discounted price (e.g., average discounted price 626) and provides a difference indicator 628 that specifies the difference to generation logic 614.

At step 406, in an example embodiment, a determination is made whether the difference is greater than a threshold. If the difference is greater than the threshold, then flow continues to step 408. Otherwise, flow continues to step 410. In another example embodiment, at step 406, a determination is made whether the difference is greater than or equal to the threshold. In accordance with this embodiment, if the difference is greater than or equal to the threshold, then flow continues to step 408. Otherwise, flow continues to step 410. In an example implementation, generation logic 614 determines whether the difference specified by difference indicator 628 is greater than (or equal to) the threshold.

In an example embodiment, the threshold is exposed as a configurable parameter to a system administrator, thereby allowing the threshold to be selected to achieve desired performance.

At step 408, a deal score is generated that indicates that the relative value of the present offer is relatively high. In an example embodiment, the deal score indicates a magnitude the difference between the discounted price and the average discounted price. For example, if the difference between a discounted price specified by present offer A and the average discounted price is larger than the difference between a discounted price specified by present offer B and the average discounted price, the deal score generated for present offer A may be greater than the deal score generated for present offer B. In an example implementation, generation logic 614 generates deal score 636 to indicate the relative value of the present offer.

At step 410, a determination is made whether the difference is less than the threshold. If the difference is less than the threshold, flow continues to step 412. Otherwise, flowchart 400 ends. In an example implementation, generation logic 614 determines whether the difference specified by difference indicator 628 is less than the threshold.

At step 412, a deal score is generated that indicates that the relative value of the present offer is relatively low. In an example implementation, generation logic 614 generates deal score 636 to indicate the relative value of the present offer.

In some example embodiments, one or more steps 402, 404, 406, 408, 410, and/or 412 of flowchart 400 may not be performed. Moreover, steps in addition to or in lieu of steps 402, 404, 406, 408, 410, and/or 412 may be performed.

FIG. 5 depicts a flowchart 500 of another example implementation of step 204 of FIG. 2 in accordance with an embodiment described herein. As shown in FIG. 5, the method of flowchart 500 begins at step 502. In step 502, a non-discounted price of the first commerce element and discounted price(s) of the second commerce element(s) are combined to provide an intermediate value. In an example implementation, combination logic 616 combines the non-discounted price of the first commerce element (e.g., non-discounted price 630) with the discounted price(s) of the second commerce element(s) (e.g., second discounted price 622) to provide intermediate value 634. For instance, combination logic 616 may average the non-discounted price of the first commerce element with the discounted price(s) of the second commerce element(s) to provide intermediate value 634.

At step 504, a difference between the discounted price specified by the present offer and the intermediate value is calculated. The difference indicates an extent to which the intermediate value is greater than the discounted price specified by the present offer. In an example implementation, difference logic 612 calculates the difference between the discounted price specified by the present offer (e.g., first discounted price 620) and the intermediate value (e.g., intermediate value 634) and provides a difference indicator 628 that specifies the difference to generation logic 614.

At step 506, in an example embodiment, a determination is made whether the difference is greater than a threshold. If the difference is greater than the threshold, then flow continues to step 508. Otherwise, flow continues to step 510. In another example embodiment, at step 506, a determination is made whether the difference is greater than or equal to the threshold. In accordance with this embodiment, if the difference is greater than or equal to the threshold, then flow continues to step 508. Otherwise, flow continues to step 510. In an example implementation, generation logic 614 determines whether the difference specified by difference indicator 628 is greater than (or equal to) the threshold.

In an example embodiment, the threshold is exposed as a configurable parameter to a system administrator, thereby allowing the threshold to be selected to achieve desired performance.

At step 508, a deal score is generated to indicate that the relative value of the present offer is relatively high. In an example embodiment, the deal score indicates a magnitude of the difference between the discounted price and the intermediate value. For example, if the difference between a discounted price specified by present offer A and the intermediate value is larger than the difference between a discounted price specified by present offer B and the intermediate value, the deal score generated for present offer A may be greater than the deal score generated for present offer B. In an example implementation, generation logic 614 generates the deal score 636 to indicate the relative value of the present offer.

At step 510, a determination is made whether the difference is less than the threshold. If the difference is less than the threshold, flow continues to step 510. Otherwise, flowchart 500 ends. In an example implementation, generation logic 614 determines whether the difference specified by difference indicator 628 is less than the threshold.

At step 512, a deal score is generated that indicates that the relative value of the present offer is relatively low. In an example implementation, generation logic 614 generates deal score 636 to indicate the relative value of the present offer.

In some example embodiments, one or more steps 502, 504, 506, 508, 510, and/or 512 of flowchart 500 may not be performed. Moreover, steps in addition to or in lieu of steps 502, 504, 506, 508, 510, and/or 512 may be performed.

It will be recognized that deal comparison module 600 may not include one or more of comparison logic 602, history logic 604, scoring logic 606, data store 608, determination logic 610, difference logic 612, generation logic 614, and/or combination logic 616. Furthermore, deal comparison module 600 may include logic in addition to or in lieu of comparison logic 602, history logic 604, scoring logic 606, data store 608, determination logic 610, difference logic 612, generation logic 614, and/or combination logic 616.

### III. Other Example Embodiments

Deal comparison module 108, deal comparison module 600, comparison logic 602, history logic 604, scoring logic 606, data store 608, determination logic 610, difference logic 612, generation logic 614, and/or combination logic 616 may be implemented in hardware, software, firmware, or any combination thereof. For example, deal comparison module 108, deal comparison module 600, comparison logic 602, history logic 604, scoring logic 606, data store 608, determination logic 610, difference logic 612, generation logic 614, and/or combination logic 616 may be implemented as computer program code configured to be executed in one or more processors. In another example, deal comparison module 108, deal comparison module 600, comparison logic 602, history logic 604, scoring logic 606, data store 608, determination logic 610, difference logic 612, generation logic 614, and/or combination logic 616 may be implemented as hardware logic/electrical circuitry.

### IV. Example Computer Implementation

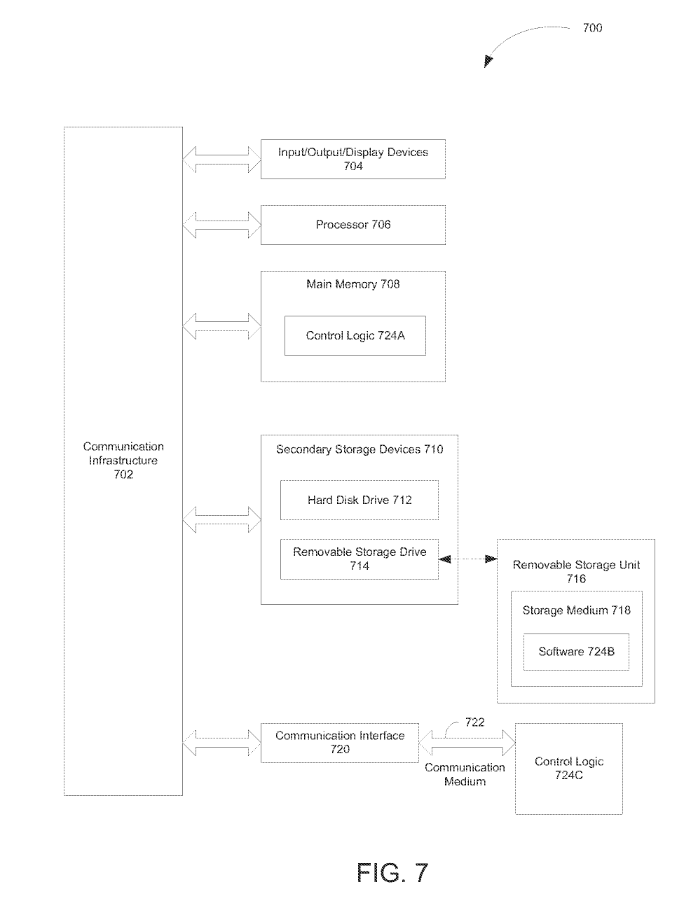

The embodiments described herein, including systems, methods/processes, and/or apparatuses, may be implemented using well known servers/computers, such as computer 700 shown in FIG. 7. For instance, elements of example system 100, including any of the user systems 102A-102M, any of the publisher servers 104A-104N, and/or merchant system 106 depicted in FIG. 1 and elements thereof, each of the steps of flowchart 200 depicted in FIG. 2, each of the steps of flowchart 300 depicted in FIG. 3, each of the steps of flowchart 400 depicted in FIG. 4, and each of the steps of flowchart 500 depicted in FIG. 5 can each be implemented using one or more computers 700.

Computer 700 can be any commercially available and well known computer capable of performing the functions described herein, such as computers available from International Business Machines, Apple, Sun, HP, Dell, Cray, etc. Computer 700 may be any type of computer, including a desktop computer, a server, etc.

As shown in FIG. 7, computer 700 includes one or more processors (e.g., central processing units (CPUs)), such as processor 706. Processor 706 may include deal comparison module 108 of FIG. 1; comparison logic 602, history logic 604, scoring logic 606, data store 608, determination logic 610, difference logic 612, generation logic 614, and/or combination logic 616 of FIG. 6; or any portion or combination thereof, for example, though the scope of the embodiments is not limited in this respect. Processor 706 is connected to a communication infrastructure 702, such as a communication bus. In some embodiments, processor 706 can simultaneously operate multiple computing threads.

Computer 700 also includes a primary or main memory 708, such as a random access memory (RAM). Main memory has stored therein control logic 724A (computer software), and data.

Computer 700 also includes one or more secondary storage devices 710. Secondary storage devices 710 include, for example, a hard disk drive 712 and/or a removable storage device or drive 714, as well as other types of storage devices, such as memory cards and memory sticks. For instance, computer 700 may include an industry standard interface, such as a universal serial bus (USB) interface for interfacing with devices such as a memory stick. Removable storage drive 714 represents a floppy disk drive, a magnetic tape drive, a compact disk drive, an optical storage device, tape backup, etc.

Removable storage drive 714 interacts with a removable storage unit 716.

Removable storage unit 716 includes a computer useable or readable storage medium 718 having stored therein computer software 724B (control logic) and/or data. Removable storage unit 716 represents a floppy disk, magnetic tape, compact disc (CD), digital versatile disc (DVD), Blu-ray disc, optical storage disk, memory stick, memory card, or any other computer data storage device. Removable storage drive 714 reads from and/or writes to removable storage unit 716 in a well-known manner.

Computer 700 also includes input/output/display devices 704, such as monitors, keyboards, pointing devices, etc.

Computer 700 further includes a communication or network interface 720. Communication interface 720 enables computer 700 to communicate with remote devices. For example, communication interface 720 allows computer 700 to communicate over communication networks or mediums 722 (representing a form of a computer useable or readable medium), such as local area networks (LANs), wide area networks (WANs), the Internet, etc. Network interface 720 may interface with remote sites or networks via wired or wireless connections. Examples of communication interface 722 include but are not limited to a modem, a network interface card (e.g., an Ethernet card), a communication port, a Personal Computer Memory Card International Association (PCMCIA) card, etc.

Control logic 724C may be transmitted to and from computer 700 via the communication medium 722.

Any apparatus or manufacture comprising a computer useable or readable medium having control logic (software) stored therein is referred to herein as a computer program product or program storage device. This includes, but is not limited to, computer 700, main memory 708, secondary storage devices 710, and removable storage unit 716. Such computer program products, having control logic stored therein that, when executed by one or more data processing devices, cause such data processing devices to operate as described herein, represent embodiments of the invention.

For example, each of the elements of deal comparison module 108 depicted in FIG. 1; comparison logic 602, history logic 604, scoring logic 606, data store 608, determination logic 610, difference logic 612, generation logic 614, and/or combination logic 616, each depicted in FIG. 6; each of the steps of flowchart 200 depicted in FIG. 2; each of the steps of flowchart 300 depicted in FIG. 3; each of the steps of flowchart 400 depicted in FIG. 4; and each of the steps of flowchart 500 depicted in FIG. 5 can be implemented as control logic that may be stored on a computer useable medium or computer readable medium, which can be executed by one or more processors to operate as described herein.

Computer readable storage media are distinguished from and non-overlapping with communication media. Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Example embodiments are also directed to such communication media.

### V. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

The proper interpretation of subject matter described and claimed herein is limited to patentable subject matter under 35 U.S.C. §101. As described and claimed herein, a method is a process defined by 35 U.S.C. §101. As described and claimed herein, each of a device, apparatus, machine, system, computer, module, computer readable media, media, is a machine or manufacture defined by 35 U.S.C. §101.

What is claimed is:

1. A method, comprising:
comparing a present offer that specifies a discounted price of at least one first commerce element and one or more other offers that specify one or more respective discounted prices of at least one second commerce element, the at least one first commerce element associated with a first category of subject matter and the at least one second commerce element associated with a second category of subject matter, each first commerce element and each second commerce element being a good or a service, the first category of subject matter and the second category of subject matter having a first measure of similarity that reaches a first threshold; and
generating a deal score for the present offer, the deal score indicating a relative value of the present offer with respect to the one or more other offers, based on the comparing of the present offer and the one or more other offers.

2. The method of claim 1, wherein the one or more other offers include one or more other present offers.

3. The method of claim 1, further comprising:
maintaining a history of past offers; and
determining one or more of the past offers that have one or more respective second measures of similarity with respect to the present offer that reach a second threshold;
wherein the one or more other offers include the one or more past offers.

4. The method of claim 3, wherein the one or more other offers further include one or more other present offers.

5. The method of claim 3, wherein the one or more second measures of similarity are based on at least a first location in which the present offer is offered and one or more second locations in which the one or more respective past offers are offered; and
wherein the one or more second measures of similarity are determined to reach the second threshold based on the first location and the one or more respective second locations being within a specified area of proximity.

6. The method of claim 3, wherein the one or more second measures of similarity are based on at least one or more differences between a first time at which the present offer is offered and one or more respective second times at which the one or more respective past offers are offered; and
wherein the one or more second measures of similarity are determined to reach the second threshold based on the one or more differences between the first time and the one or more respective second times being less than a third threshold.

7. The method of claim 1, wherein generating the deal score comprises:
determining an average of the one or more discounted prices specified by the one or more respective other offers to provide an average discounted price;
calculating a difference between the discounted price specified by the present offer and the average discounted price, the difference indicating an extent to which the average discounted price is greater than the discounted price specified by the present offer;
generating the deal score to indicate that the relative value of the present offer is relatively high if the difference is greater than a second threshold but not if the difference is less than the second threshold; and
generating the deal score to indicate that the relative value of the present offer is relatively low if the difference is less than the second threshold but not if the difference is greater than the second threshold.

8. The method of claim 1, wherein generating the deal score comprises:
combining a non-discounted price of the first commerce element with the one or more discounted prices of the at least one second commerce element to provide an intermediate value;
calculating a difference between the discounted price specified by the present offer and the intermediate value, the difference indicating an extent to which the intermediate value is greater than the discounted price specified by the present offer;
generating the deal score to indicate that the relative value of the present offer is relatively high if the difference is greater than a second threshold but not if the difference is less than the second threshold; and
generating the deal score to indicate that the relative value of the present offer is relatively low if the difference is less than the second threshold but not if the difference is greater than the second threshold.

9. A system, comprising:
comparison logic configured to compare a present offer that specifies a discounted price of at least one first commerce element and one or more other offers that specify one or more respective discounted prices of at least one second commerce element, the at least one first commerce element associated with a first category of subject matter and the at least one second commerce element associated with a second category of subject matter, each first commerce element and each second commerce element being a good or a service, the first category of subject matter and the second category of subject matter having a first measure of similarity that reaches a first threshold; and
scoring logic configured to generate a deal score for the present offer, the deal score indicating a relative value of the present offer with respect to the one or more other offers, based on the comparing of the present offer and the one or more other offers.

10. The system of claim 9, wherein the one or more other offers include one or more other present offers.

11. The system of claim 9, further comprising:
history logic configured to maintain a history of past offers;
wherein the comparison logic is configured to determine one or more of the past offers that have one or more respective second measures of similarity with respect to the present offer that reach a second threshold; and
wherein the one or more other offers include the one or more past offers.

12. The system of claim 11, wherein the one or more other offers further include one or more other present offers.

13. The system of claim 11, wherein the one or more second measures of similarity are based on at least a first location in which the present offer is offered and one or more second locations in which the one or more respective past offers are offered; and
wherein the comparison logic is configured to determine whether the one or more second measures of similarity reach the second threshold based on whether the first location and the one or more respective second locations are within a specified area of proximity.

14. The system of claim 11, wherein the one or more second measures of similarity are based on at least one or more differences between a first time at which the present offer is offered and one or more respective second times at which the one or more respective past offers are offered; and
wherein the comparison logic is configured to determine whether the one or more second measures of similarity reach the second threshold based on whether the one or more differences between the first time and the one or more respective second times are less than a third threshold.

15. The system of claim 9, wherein the scoring logic further comprises:
determination logic configured to determine an average of the one or more discounted prices specified by the one or more respective other offers to provide an average discounted price;
difference logic configured to calculate a difference between the discounted price specified by the present offer and the average discounted price, the difference indicating an extent to which the average discounted price is greater than the discounted price specified by the present offer; and
generation logic configured to generate the deal score to indicate that the relative value of the present offer is relatively high if the difference is greater than a second threshold but not if the difference is less than the second threshold, and to generate the deal score to indicate that the relative value of the present offer is relatively low if the difference is less than the second threshold but not if the difference is greater than the second threshold.

16. The system of claim 9, wherein the scoring logic further comprises:
combination logic configured to combine a non-discounted price of the first commerce element with the one or more discounted prices of the at least one second commerce element to provide an intermediate value;
difference logic configured to calculate a difference between the discounted price specified by the present offer and the intermediate value, the difference indicating an extent to which the intermediate value is greater than the discounted price specified by the present offer; and
generation logic configured to generate the deal score to indicate that the relative value of the present offer is relatively high if the difference is greater than a second threshold but not if the difference is less than the second threshold, and to generate the deal score to indicate that the relative value of the present offer is relatively low if the difference is less than the second threshold but not if the difference is greater than the second threshold.

17. A computer program product comprising a computer-readable medium having computer program logic recorded thereon for enabling a processor-based system to provide a deal score to one or more users, the computer program product comprising:
a first program logic module for enabling the processor-based system to compare a present offer that specifies a discounted price of at least one first commerce element and one or more other offers that specify one or more respective discounted prices of at least one second commerce element, the at least one first commerce element associated with a first category of subject matter and the at least one second commerce element associated with a second category of subject matter, each first commerce element and each second commerce element being a good or a service, the first category of subject matter and the second category of subject matter having a first measure of similarity that reaches a first threshold; and
a second program logic module for enabling the processor-based system to generate a deal score for the present offer, the deal score indicating a relative value of the present offer with respect to the one or more other offers, based on the comparing of the present offer and the one or more other offers.

18. The computer program product of claim 17, further comprising:
a third program logic module for enabling the processor-based system to maintain a history of past offers;
a fourth program logic module for enabling the processor-based system to determine one or more of the past offers that have one or more respective second measures of similarity with respect to the present offer that reach a second threshold, the one or more second measures of similarity being based on at least a first location in which the present offer is offered and one or more second locations in which the one or more respective past offers are offered; and
a fifth program logic module for enabling the processor-based system to determine whether the one or more second measures of similarity reach the second threshold based on whether the first location and the one or more respective second locations are within a specified area of proximity;
wherein the one or more other offers include the one or more past offers.

19. The computer program product of claim 17, further comprising:
a third program logic module for enabling the processor-based system to maintain a history of past offers;
a fourth program logic module for enabling the processor-based system to determine one or more of the past offers that have one or more respective second measures of similarity with respect to the present offer that reach a second threshold, the one or more second measures of similarity being based on at least one or more differences between a first time at which the present offer is offered and one or more respective second times at which the one or more respective past offers are offered; and
a fifth program logic module for enabling the processor-based system to determine whether the one or more second measures of similarity reach the second threshold based on whether the one or more differences between the first time and the one or more respective second times are less than a third threshold;
wherein the one or more other offers include the one or more past offers.

20. The computer program product of claim 17, wherein the second program logic module further comprises:
a third program logic module for enabling the processor-based system to combine a non-discounted price of the first commerce element with the one or more discounted prices of the at least one second commerce element to provide an intermediate value;
a fourth program logic module for enabling the processor-based system to calculate a difference between the discounted price specified by the present offer and the intermediate value, the difference indicating an extent to which the intermediate value is greater than the discounted price specified by the present offer; and
a fifth program logic module for enabling the processor-based system to generate the deal score to indicate that the relative value of the present offer is relatively high if the difference is greater than a second threshold but not if the difference is less than the second threshold, and to generate the deal score to indicate that the relative value of the present offer is relatively low if the difference is less than the second threshold but not if the difference is greater than the second threshold.
